(19) United States
(12) Patent Application Publication
(10) Pub. No.: US 2024/0231764 A9
(43) Pub. Date: Jul. 11, 2024

(54) AUTOMATIC PROGRAM CODE GENERATION DEVICE AND PROGRAM

(71) Applicant: SOPPRA CORPORATION, Osaka-shi, Osaka (JP)

(72) Inventor: Motomitsu SHIRAKAWA, Osaka (JP)

(73) Assignee: SOPPRA CORPORATION, Osaka-shi, Osaka (JP)

(21) Appl. No.: 18/277,880

(22) PCT Filed: Jan. 18, 2022
(86) PCT No.: PCT/JP2022/001580

§ 371 Date: Aug. 18, 2023

(30) Foreign Application Priority Data
Mar. 10, 2021 (JP) 2021-038519

(51) Int. Cl. G06F 8/33

(52) U.S. Cl. CPC G06F 8/33

(57) ABSTRACT

Text data is extracted from a document. Referring to a first trained model in which text data is associated with a semantic content with an association degree, a semantic content highly relevant to the text data is searched. Referring to a second trained model in which the semantic content is associated with program code basic syntax with an association degree, highly relevant program code basic syntax is extracted based on the semantic content.

### TECHNICAL FIELD

The present invention relates to an automatic program code generation device and a program appropriate for automatically generating a program code according to a semantic content of text data included in a document.

### BACKGROUND ART

When a new operation is automatically performed by a program, the work of creating a program is necessary. In creating a program, conventionally, a process of defining a requirement of the new operation, designing a system, further, developing a program code, and then testing and verifying it occurs. Such a program code is usually coded manually every time when a new operation occurs.

However, with rapid progress of IT introduction in recent years, a wide variety of new operations occurs, and the frequency of the occurrence of them has increased.

Even a simple work within a company needs to be changed as needed depending on a situation in some cases. For example, even when an in-house operation of “notifying a superior of overtime hours of an employee XX for this month” is program-coded and can be automatically performed, the program code needs to be rewritten every time when the “employee XX” or the “superior” is changed because of transfer or the like.

Thus, the increase of the new operation and the manual generation of the program code in each change of operation contents make the workload enormous, and a problem arises in that not only the work burden on workers increases, but also a delay in work possibly hinders the operation flow.

Therefore, conventionally, to automatically perform an operation by a system in a computer side, there has been proposed an automatic program code generation device capable of very easily and automatically generating a program code without manpower in generating the program code for performing the operation (for example, see Patent Document 1).
Patent Document 1: Japanese Patent No. 6753598

### DISCLOSURE OF THE INVENTION

### Problems to be Solved by the Invention

However, the above-described technique disclosed in Patent Document 1 only accepts a conversational sentence and searches basic syntax of a program code via an intent that the conversational sentence intends. That is, it is a technique specialized in automatically generating a program code corresponding to one phrase uttered as words. Therefore, in the technique disclosed in Patent Document 1, there is a problem that thousands of or tens of thousands of sentences included in various kinds of documents, such as a design sheet, a manual, a specification, and various kinds of written explanations and written plans, cannot be automatically program-coded.

When program codes corresponding to respective sentences described in such documents can be automatically generated, the way is paved for automation of all operations having depended on manpower so far. Therefore, while a demand for a technique of automatically and accurately generating a program code corresponding to a semantic content of a document by simply reading the document has been increasing in recent years, a technique meeting the demand has not been proposed yet under the current situation.

Accordingly, the present invention has been devised in consideration of the above-described problem, and it is an object of the present invention to provide an automatic program code generation device and a program capable of automatically and accurately generating a program code corresponding to a semantic content of a document by simply reading the document.

### Solutions to the Problems

A first invention includes text data extracting means, semantic content searching means, and code extracting means. The text data extracting means extracts text data as a text from a document. The semantic content searching means refers to a first association in which text data from which individual components of a text including a verb, a noun, and a case component are extracted by a morphological analysis is associated with a semantic content, and searches a semantic content highly relevant to the text data extracted by the text data extracting means. The code extracting means refers to a second association in which the semantic content is associated with program code basic syntax, and extracts highly relevant program code basic syntax based on the semantic content searched by the semantic content searching means.

In a second invention, which is in the first invention, the semantic content searching means refers to the first association in which the text data is associated with the semantic content with an association degree of three or more levels, and the code extracting means refers to the second association in which the semantic content is associated with the program code basic syntax with an association degree of three or more levels.

In a third invention, which is in the second invention, the semantic content searching means and the code extracting means use the association degree corresponding to weighting factors of respective outputs of nodes in a neural network of artificial intelligence.

A fourth invention, which is in any of the first invention to the third invention, further includes updating means that updates the first association based on a data set in which semantic contents are preliminarily assigned to respective texts and respective signs included in the text data. The text data extracting means extracts the respective texts and the respective signs included in the text data. The semantic content searching means refers to the first association updated by the updating means, and searches semantic contents highly relevant to the respective texts and the respective signs included in the text data extracted by the text data extracting means.

A fifth invention, which is in any of the first invention to the fourth invention, includes code generating means that generates a program code by assigning a noun or a noun phrase extracted from the text data accepted by the text data extracting means to the program code basic syntax extracted by the code extracting means.

A sixth invention causes a computer to execute: a text data extracting step of extracting text data as a text from a document; a semantic content searching step of referring to a first association in which text data from which individual components of a text including a verb, a noun, and a case component are extracted by a morphological analysis is associated with a semantic content, and searching a semantic content highly relevant to the text data extracted by the text data extracting step; and a code extracting step of referring to a second association in which the semantic content is associated with program code basic syntax, and extracting highly relevant program code basic syntax based on the semantic content searched by the semantic content searching step.

In a seventh invention, which is in the sixth invention, the semantic content searching step refers to the first association in which the text data is associated with the semantic content with an association degree of three or more levels, and the code extracting step refers to the second association in which the semantic content is associated with the program code basic syntax with an association degree of three or more levels.

In an eighth invention, which is in the seventh invention, the semantic content searching step and the code extracting step use the association degree corresponding to weighting factors of respective outputs of nodes in a neural network of artificial intelligence.

A ninth invention, which is in the sixth invention to the eighth invention, further includes an updating step of updating the first trained model based on a data set in which semantic contents are preliminarily assigned to respective texts and respective signs included in the text data. The text data extracting step extracts the respective texts and the respective signs included in the text data. The semantic content searching step refers to the first trained model updated by the updating step, and searches semantic contents highly relevant to the respective texts and the respective signs included in the text data extracted by the text data extracting step.

A tenth invention, which is in any of the sixth invention to the ninth invention, further includes a code generating step of generating a program code by assigning a noun or a noun phrase extracted from the text data accepted by the text data extracting step to the program code basic syntax extracted by the code extracting step.

### Effects of the Invention

According to the above-described invention, thousands of or tens of thousands of sentences included in various kinds of documents, such as a design sheet, a manual, a specification, and various kinds of written explanations and written plans, can be very easily and automatically program-coded without manpower.

### BRIEF DESCRIPTION OF THE DRAWINGS

FIG. 1 is a block diagram of an automatic program code generation system according to an embodiment.

FIG. 2A and FIG. 2B are schematic diagrams illustrating an exemplary configuration of an automatic program code generation device 1.

FIG. 3 is a diagram illustrating an example of a first trained model.

FIG. 4 is a diagram illustrating an example of a code table using machine learning with artificial intelligence for the first trained model.

FIG. 5 is a diagram illustrating a model in which text data is input as input data and a semantic content is output as output data.

FIG. 6 is a diagram illustrating an example of a second trained model.

FIG. 7 is a diagram illustrating an example of using machine learning with artificial intelligence for the second trained model.

FIG. 8 is a diagram illustrating a model in which a semantic content is input as input data and a program code is output as output data.

FIG. 9 is a flowchart for describing an operation of the automatic program code generation system to which the present invention is applied.

FIG. 10 is a diagram for describing a first association and a second association.

FIG. 11 is a diagram illustrating an example of extracting text data from a document (a design sheet or a document file).

### DESCRIPTION OF PREFERRED EMBODIMENTS

The following describes an example of an automatic program code generation system according to an embodiment of the present invention by referring to the drawings.

### Embodiment: Automatic Program Code Generation System 100

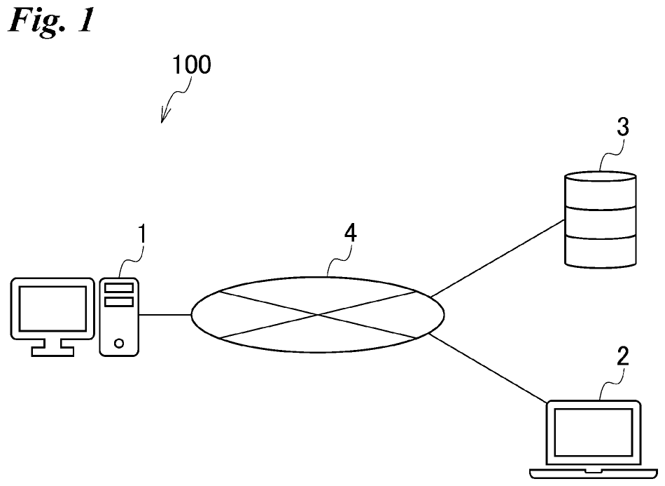

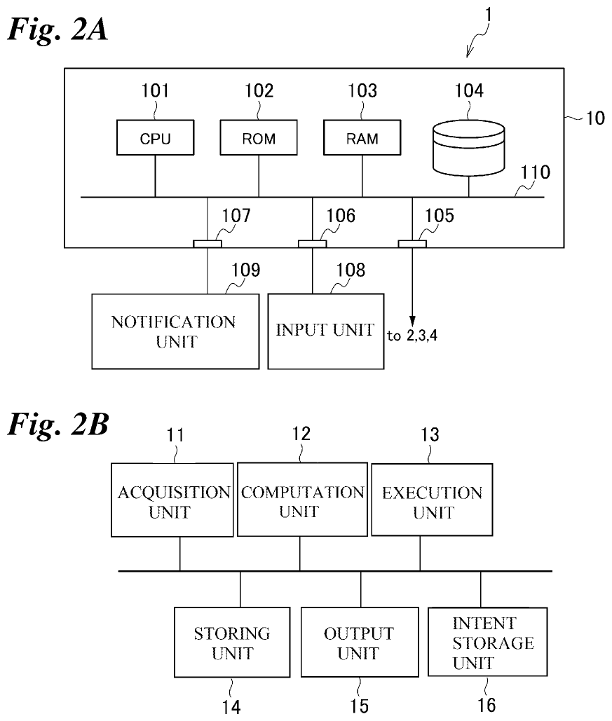

With reference to FIG. 1 to FIG. 2, an exemplary configuration of an automatic program code generation system 100 according to the embodiment will be described. FIG. 1 is a schematic diagram illustrating an overall configuration of the automatic program code generation system 100 according to the embodiment.

The automatic program code generation system 100 is used mainly for generating a program code for achieving assistance for an operation such as a routine work (for example, an operation automation process). The automatic program code generation system 100 automatically generates a program code for performing an operation, thereby allowing automatically performing each operation in a company (for example, execution of an operation flow described in a manual, collection of progress statuses of workers, and task management) on a computer. In the automatic program code generation system 100, especially, the automatic generation of a program code can be set based on text data, and even a user without expertise (for example, a user who manages an operation using the automatic program code generation system 100), unlike a system manager and the like, can easily achieve the automatic generation of a program code for causing a computer to automatically perform operation flows described in respective documents.

For example, as illustrated in FIG. 1, the automatic program code generation system 100 may include an automatic program code generation device 1, and a user may use the automatic program code generation device 1. The automatic program code generation system 100 may include, for example, a terminal 2 connected to the automatic program code generation device 1 via a communications network 4, and the user may use the automatic program code generation device 1 via the terminal 2. The automatic program code generation system 100 may include, for example, a server 3 connected to the automatic program code generation device 1 via the communications network 4, and the user may achieve each means by transmitting and receiving various kinds of information to and from the server 3 via the automatic program code generation device 1 or the terminal 2.

### <Automatic Program Code Generation Device 1>

FIG. 2A is a schematic diagram illustrating an exemplary configuration of the automatic program code generation device 1. As the automatic program code generation device 1, for example, a publicly known electronic device, such as a personal computer (PC), a smartphone, and a tablet terminal, is used. The automatic program code generation device 1 includes, for example, a housing 10, a Central Processing Unit (CPU) 101, a Read Only Memory (ROM) 102, a Random Access Memory (RAM) 103, a storage unit 104, I/Fs 105 to 107, an input unit 108, and a notification unit 109. The components 101 to 107 are mutually connected by an internal bus 110.

The CPU 101 controls the whole automatic program code generation device 1. The ROM 102 stores an operation code of the CPU 101. The RAM 103 is a work area used during an operation of the CPU 101. The storage unit 104 stores various kinds of information, such as process data. As the storage unit 104, for example, a Hard Disk Drive (HDD) or a Solid State Drive (SSD) is used.

The I/F 105 is an interface for transmitting and receiving various kinds of information to and from the terminal 2, the server 3, the communications network 4, and the like. The I/F 106 is an interface for transmitting and receiving various kinds of information to and from the input unit 108. The I/F 107 is an interface for transmitting and receiving various kinds of information to and from the notification unit 109.

As the input unit 108, a keyboard is used, and additionally, a device such as a camera and a scanner may be used. A user using the automatic program code generation device 1 reads, for example, text data of various kinds of documents via the input unit 108. The document here is a document including a design sheet, a manual, a specification, and various kinds of written explanations and written plans, but is not limited thereto, and any document documented by an individual or in a company is included. Additionally, not only a published material that a large indefinite number of people can actually read but also a document that only a specified person can read are included. A handwritten note is also included in the document. These documents are not limited to those provided via printed matter printed on paper media, but may be provided as electronic data.

The input unit 108 includes any device to which data of the document is input. When the document is provided as printed matter printed on a paper medium, the input unit 108 is configured by a scanner or OCR software that can read text data of the printed matter. When the document is configured by electronic data, the input unit 108 may be configured by OCR software that can read text data of the electronic data.

The notification unit 109 indicates various kinds of information, such as display data stored in the storage unit 104, a process status of the automatic program code generation device 1, and the like. As the notification unit 109, a display is used, and additionally, for example, a speaker may be used.

For example, the OF 105 to the OF 107 may be the same interface, and for example, a plurality of interfaces may be used for each of the OF 105 to the OF 107. When a touch panel display is used as the notification unit 109, the notification unit 109 may have a configuration including the input unit 108.

FIG. 2B is a schematic diagram illustrating an exemplary function of the automatic program code generation device 1. The automatic program code generation device 1 includes an acquisition unit 11 and a computation unit 12, and may include, for example, an execution unit 13, a storing unit 14, an output unit 15, and an intent storage unit 16. Each of the functions illustrated in FIG. 2B is achieved by executing a program stored in the storage unit 104 and the like by the CPU 101 using the RAM 103 as a work area. Each of the functions may be partially controlled by artificial intelligence. Here, the “artificial intelligence” may be based on any well-known artificial intelligence technique.

### <Acquisition Unit 11>

The acquisition unit 11 acquires text data of the document. For example, the acquisition unit 11 acquires text data input from the document via the terminal 2 or the input unit 108. For example, when text data is extracted from the document via the terminal 2 or the input unit 108, the acquisition unit 11 recognizes characters of the text data using a publicly known OCR technique. As the character recognition technique, for example, a cloud-based character recognition technique may be used via the communications network 4.

### <Computation Unit 12>

The computation unit 12 refers to a database, and executes various kinds of process operations and computations based on the acquired text data. The computation unit 12 performs a morphological analysis on the accepted text data, thereby extracting individual components of a sentence including a verb, a noun, a case component, and the like. The computation unit 12 refers to the storing unit 14, and extracts basic syntax of a program code corresponding to the text data. The computation unit 12 assigns a noun or a noun phrase extracted from a character string constituting the text data to the extracted program code basic syntax, thereby generating a program code.

### <Execution Unit 13>

The execution unit 13 executes an operation process based on the program code generated by the computation unit 12. Examples of the operation process include routine works, such as sending e-mail to a person responsible based on a content and a deadline of a task, attendance management, and updating a task progress history, and a content that can be executed by a computer using operation process information as a program is used.

### <Storing Unit 14>

The storing unit 14 temporarily stores the text data acquired via the acquisition unit 11. The text data stored in the storing unit 14 is read and is updated in some cases based on control by the computation unit 12, the execution unit 13, and the like. The storing unit 14 holds at least two trained models of a first trained model and a second trained model.

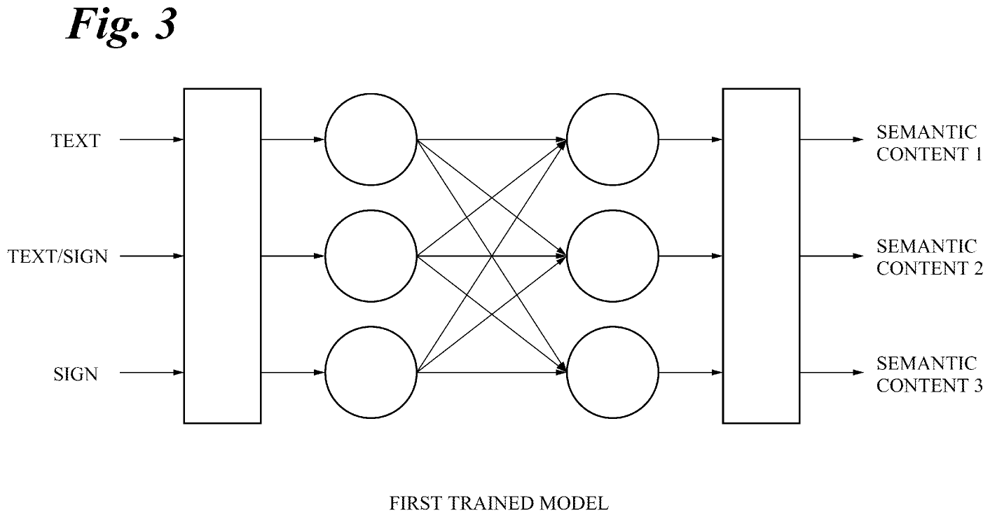

FIG. 3 illustrates an example of the first trained model. The first trained model is a trained model in which text data extracted from a document is associated with its semantic content with an association degree of three or more levels. In the first trained model, the text data is an input, and the semantic content is an output. The type of the text data includes a text, a combination of a text and a sign, and a sign alone.

For example, when text data in an input side is “a file “A” is changed to a file “B” and placed in a folder “C”,” a semantic content of “a name of a file “A” is changed to a file “B” and it is copied in a folder C” in an output side is associated with the highest association degree.

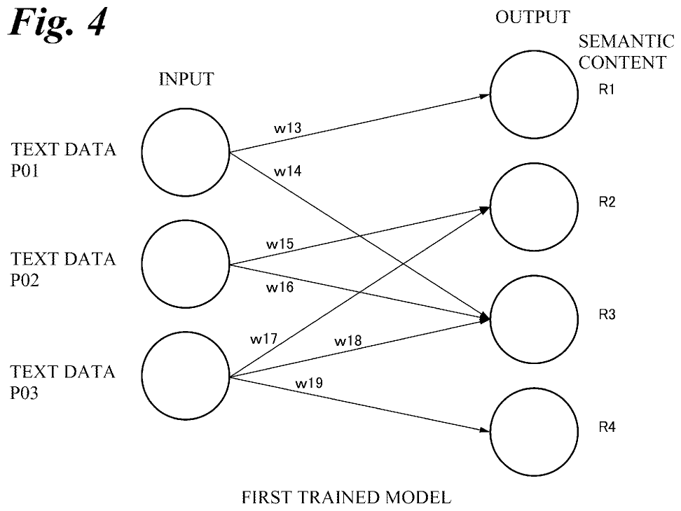

When machine learning or deep learning with artificial intelligence is used for the first trained model, for example, as illustrated in FIG. 4, it is presupposed that the association degree of three or more levels between the text data and the semantic content is preliminarily set. For example, assume that input data is text data P01 to P03. For example, assume that the text data P01 is “a file “A” is changed to a file “B” and placed in a folder “C”,” the text data P02 is “a file “B” is matched to a file “A”,” and the text data P03 is “a file “A” and a file “B” are output.” Each piece of the text data P01 to P03 as the input data is coupled to semantic contents R1 to R4 as outputs.

The semantic content is not limited to a configuration of a character string that a person can actually read and understand as described above, and may be represented by a sign indicating the semantic content, or may be represented by a parameter or the like.

The text data is mutually associated with the semantic content (for example, “a name of a file “A” is changed to a file “B” and it is copied in a folder “C”” as the semantic content R1) as an output solution with an association degree of three or more levels. The text data is arranged on the left side via the association degree, and the semantic contents are arranged on the right side via the association degree. The association degree is a degree indicating which semantic content the text data arranged on the left side is highly relevant to. In other words, the association degree is an index indicating which semantic content each piece of the text data is highly possibly associated with, and indicates the appropriateness in selecting the most probable semantic content from the text data. In the example of FIGS. 4, w13 to w19 are illustrated as the association degrees. w13 to w19 are indicated by 10 levels as illustrated in Table 1 below, and while it is indicated that the closer to 10 points they become, the higher the degree of relevance between each combination as an intermediate node and the semantic content as an output becomes, it is indicated that the closer to 1 point they become, the lower the degree of relevance between each combination as an intermediate node and the semantic content as an output becomes.

TABLE 1

| Reference Numeral | Association Degree |
|---|---|
| w13 | 7 |
| w14 | 2 |
| w15 | 9 |
| w16 | 5 |
| w17 | 2 |
| w18 | 1 |
| w19 | 8 |
| w20 | 6 |
| w21 | 10 |
| w22 | 3 |

The association degrees w13 to w19 of three or more levels as illustrated in FIG. 4 are acquired in advance. That is, the association degrees illustrated in FIG. 4 are preliminarily produced by accumulating a past data set including the text data P01 to P03 and the semantic contents R1 to R4 employed and evaluated in the actual determination of a search solution, and performing analytics and an analysis of them.

For example, assume that the semantic content R1 was determined to be most highly associated with the text data P01 and evaluated in the past. By collecting such data sets and analyzing them, the association degree with the semantic content is increased.

The analytics and analysis may be performed by artificial intelligence. In this case, for example, in the case of the text data P01, when the number of cases of the semantic content R1 is large, the association degree connected to the semantic content R1 is set to be higher, and when the number of cases of the semantic content R2 is large, the association degree connected to the semantic content R2 is set to be higher. For example, the text data P01 is linked to the semantic content R1 and the semantic content R2, and while the association degree w13 connected to the semantic content R1 is set at 7 points, the association degree w14 connected to the semantic content R2 is set at 2 points based on the past cases.

Note that the same applies to a case where the text data is configured of a sign, and what semantic content each sign is interpreted in is learned from the past data set. This allows searching the semantic content from the sign by referring to the first trained model.

The association degree illustrated in FIG. 4 may be configured of nodes of a neural network in artificial intelligence. That is, the nodes of the neural network function as weighting factors to the output, and correspond to the above-described association degree. Not limited to the neural network, the association degree may be configured of any decision factor constituting artificial intelligence.

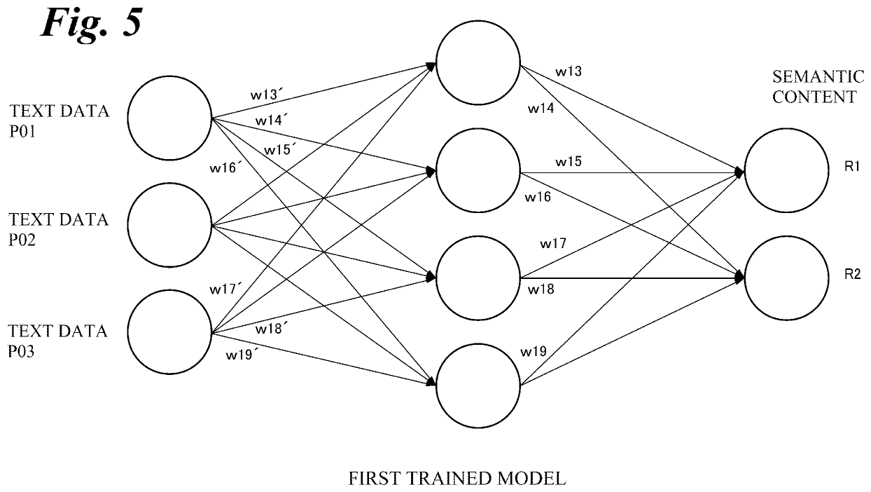

In this case, as illustrated in FIG. 5, the text data may be input as input data, the semantic content may be output as output data, at least one or more hidden layers may be provided between an input node and an output node, and machine learning may be performed. The above-described association degree is set at any one of the input node or a hidden layer node or both of them, the association degree functions as weighting of each node, and the output is selected based on this. Then, the output may be selected when the association degree exceeds a certain threshold value.

The association degree as described above is used as the first trained model. After creating the first trained model like this, the semantic content can be actually searched from the text data.

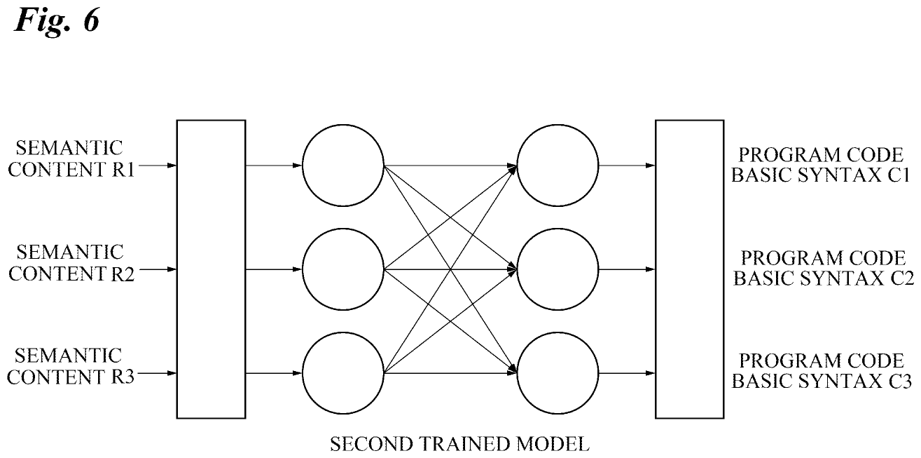

FIG. 6 illustrates an example of a second trained model. The second trained model is a trained model in which a semantic content is associated with basic syntax of a program code with an association degree of three or more levels. In the second trained model, the semantic content is an input, and the program code basic syntax is an output. In the second trained model, the semantic content in the input side corresponds to the output side in the first trained model.

For example, when the semantic content in the input side is “a name of a file “A” is changed to a file “B” and it is copied in a folder C,” “cpA./C/B (copy A to folder/B)” as program code basic syntax in the output side is associated with the highest association degree.

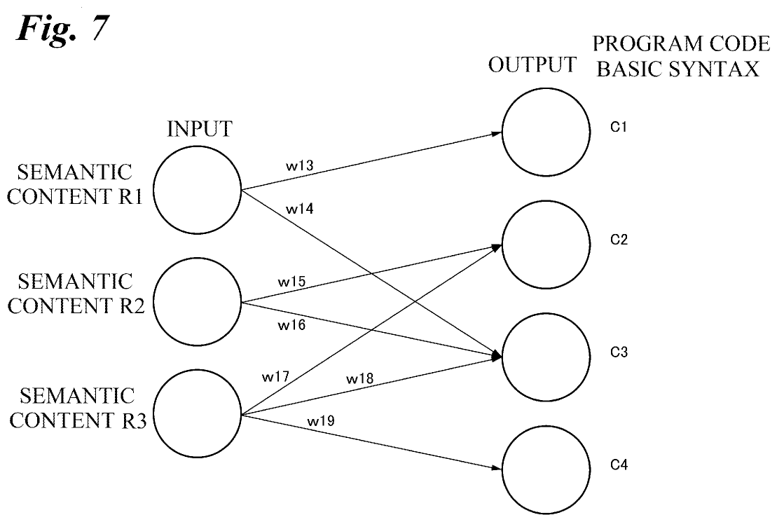

When machine learning or deep learning with artificial intelligence is used for the second trained model, for example, as illustrated in FIG. 7, it is presupposed that the association degree of three or more levels between the semantic content and the program code basic syntax is preliminarily set. For example, assume that input data is semantic contents R1 to R3.

That is, the semantic contents R1 to R3 are mutually associated with program code basic syntax C1 to C4 as an output solution with an association degree of three or more levels. The semantic contents R1 to R3 are arranged on the left side via the association degree, and each of the program code basic syntax C1 to C4 is arranged on the right side via the association degree. The association degree is a degree indicating which program code basic syntax C1 to C4 the semantic contents R1 to R3 arranged on the left side are highly relevant to. In other words, the association degree is an index indicating which program code basic syntax C1 to C4 each of the semantic contents R1 to R3 is highly possibly associated with, and indicates the appropriateness in selecting the most probable program code basic syntax from the semantic content. In the example of FIGS. 7, w13 to w19 are illustrated as examples of the association degree.

The association degrees w13 to w19 of three or more levels as illustrated in FIG. 7 are acquired in advance. That is, the association degrees illustrated in FIG. 7 are preliminarily produced by accumulating a past data set including the semantic contents R1 to R3 and the program code basic syntax C1 to C4 employed and evaluated in the actual determination of a search solution, and performing analytics and an analysis of them.

For example, assume that the program code basic syntax C3 was determined to be most highly associated with the semantic content R2 and evaluated in the past. By collecting such data sets and analyzing them, the association degree with the semantic content is increased.

The analytics and analysis may be performed by artificial intelligence. In this case, for example, in the case of the semantic content R2, when the number of cases of the program code C2 is large, the association degree connected to the program code C2 is set to be higher, and when the number of cases of the program code C3 is large, the association degree connected to the program code C3 is set to be higher.

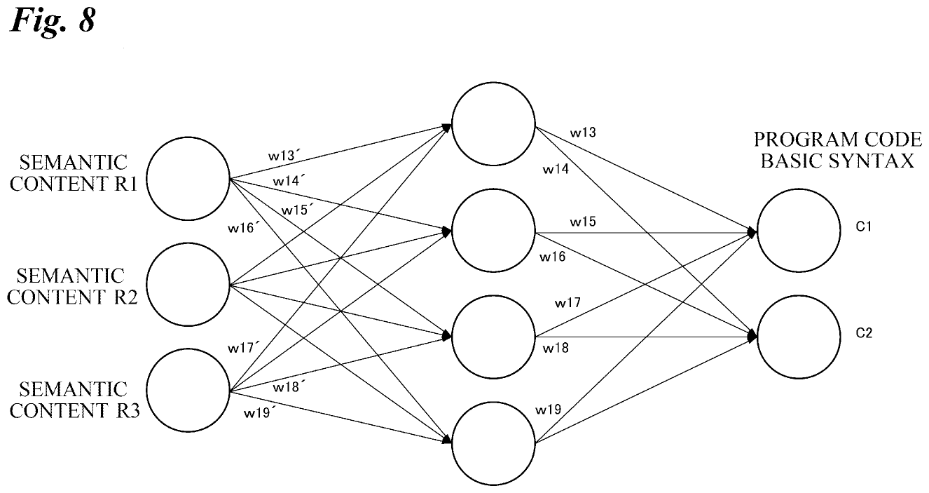

The association degree illustrated in FIG. 7 may be configured of nodes of a neural network in artificial intelligence. In this case, as illustrated in FIG. 8, the semantic content may be input as input data, the program code may be output as output data, at least one or more hidden layers may be provided between an input node and an output node, and machine learning may be performed.

The association degree as described above is used as the second trained model. After creating the second trained model like this, the program code basic syntax can be actually searched from the semantic content.

Storing the first trained model and the second trained model as described above in the storing unit 14 allows reading and referring to them in the process of computation by the computation unit 12.

### <Output Unit 15>

The output unit 15 outputs various kinds of information regarding an operation executed by the program code. The display data is notified so as to be recognized by the user via the notification unit 109, the terminal 2, or the like. The output unit 15 outputs the display data and the like to the terminal 2 and the like via the OF 105, and outputs the display data and the like to the notification unit 109 via the OF 107.

### <Intent Storage Unit 16>

The intent storage unit 16 stores one or two or more intents. The intent may be stored in the intent storage unit 16 having correspondence with information for identifying an operation process. The information for identifying the operation process is usually an action name described later, but its format is not limited thereto. The correspondence includes, for example, a case where the intent has the information for identifying the operation process.

### <Terminal 2>

As the terminal 2, for example, a publicly known electronic device, such as a personal computer, a smartphone, and a tablet terminal, is used. The terminal 2 may have, for example, a configuration and at least a part of functions similar to those of the automatic program code generation device 1 described above. For example, a plurality of the terminals 2 may be included, and each of the terminals 2 may be connected to the automatic program code generation device 1 via the communications network 4.

### <Server 3>

The server 3 stores, for example, the above-described various kinds of information. The server 3 accumulates, for example, various kinds of information transmitted from the automatic program code generation device 1 and the like via the communications network 4. For example, the server 3 may store information similar to the storage unit 104, and may transmit and receive various kinds of information to and from the automatic program code generation device 1 and the like via the communications network 4. That is, in the automatic program code generation system 100, the server 3 may be used instead of the automatic program code generation device 1 or the storage unit 104 and the storing unit 14 of the automatic program code generation device 1.

### <Communications Network 4>

The communications network 4 is an Internet network or the like to which the automatic program code generation device 1 is connected via a communication circuit. The communications network 4 may be configured of what is called an optical fiber communications network. The communications network 4 may be achieved by a publicly known communications network, such as a wired communication network and a wireless communication network.

Next, an operation of the automatic program code generation system 100 to which the present invention is applied will be described.

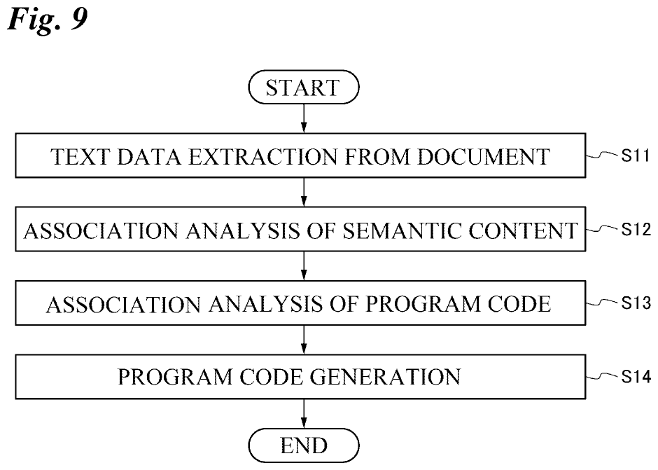

As illustrated in FIG. 9, in Step S11, text data is extracted from a document. Specifically, character strings are acquired as electronic data from the document via a camera, a scanner, or the like constituting the input unit 108. When a scanner or the like is used, an OCR technique is used for character recognition, thereby acquiring the text data. When the text data as electronic data is acquired in the acquisition unit 11, it is directly used. The text data acquired as described above is temporarily stored in the storing unit 14.

Next, the process proceeds to Step S12, the text data acquired in Step S11 and temporarily stored in the storing unit 14 is read, and an association analysis of the semantic content is performed. The computation unit 12 reads the first trained model stored in the storing unit 14, and refers to it, thereby searching the semantic content having a high association degree with the text data. In this case, for example, as illustrated in FIG. 4, when additionally acquired text data is same as or similar to P02, it is associated with the semantic content R2 with the association degree w15, and associated with the semantic content R3 with the association degree w16. In this case, the semantic content R2 having the highest association degree is selected as an optimal solution.

Next, the process proceeds to Step S13, and an association analysis with the program code basic syntax is performed. In this case, the association analysis with the program code basic syntax most relevant to the semantic content searched in Step S12. In this case, for example, as illustrated in FIG. 7, when additionally acquired semantic content is same as or similar to R2, it is associated with the program code basic syntax C2 with the association degree w15, and associated with the program code basic syntax C3 with the association degree w16. In this case, the program code basic syntax C2 having the highest association degree is selected as the optimal solution.

Through Steps S12 and S13, the semantic content most relevant to the text data extracted from the document can be searched, and the program code basic syntax most relevant to the searched semantic content can be obtained as the optimal solution. After extracting the text data from the document, the optimal solution of the program code basic syntax can be automatically obtained. Then, to each piece of the extracted text data, the searched program code basic syntax can be assigned.

Next, the process proceeds to Step S14, and the program code is generated. Step S13 only extracts the program code basic syntax as described above, and the program code is completed by assigning nouns or noun phrases specifying objects of an actual process operation and conditions necessary for completing the process operation. Therefore, Step S14 performs a process operation of assigning nouns or noun phrases specifying objects of an actual process operation and conditions necessary for completing the process operation to the extracted program code basic syntax.

In this case, a morphological analysis is performed on the text data to extract the nouns or the noun phrases specifying the objects of the actual process operation and the conditions necessary for completing the process operation. The morphological analysis is performed mainly by the computation unit 12. For a morphological analysis technique, any well-known morphological analysis technique may be used.

For example, assume that in text data of “register A5-7853K,” the program code basic syntax “INSERT INTO product master (product name) VALUES ({parame1})” can be extracted in Step S14. At this time, an actual product name to be filled in {parame1} is picked up from an imperative sentence on which the morphological analysis has been performed. As a result, “A5-7853K” is picked up as the product name, and it is assigned to the basic syntax, thus allowing completing the program code.

Similarly, in “transmit overtime hours of employees for this month,” the program code basic syntax “SELECT time FROM overtime work data WHERE date={param1} AND employee={param2}” is extracted in Step S14, and “this month” and each employee name (for example, “Taro Yamada”) are picked up from the imperative sentence on which the morphological analysis has been performed, and assigned to {parame1} of date and {param2} of employee of the basic syntax, respectively, thus allowing completing the program code.

In the processes of Steps S11 to S14, a program can be automatically generated based on intentions of respective actions described in the text data accepted in Step S11.

After completing the program code as described above, the program code may be provided to the user, or may be indicated via the notification unit 109, and the completed program code may be executed via the execution unit 13. That is, according to the present invention, the automatically generated program code can be directly executed. Therefore, when the processes from Step S11 are included, extracting text data from a document allows automatically generating a program code in which its intention is incorporated, and further allows directly executing the generated program code.

Therefore, the present invention allows automatic and accurate program coding by simply reading thousands of or tens of thousands of sentences included in various kinds of documents, such as a design sheet, a manual, a specification, and various kinds of written explanations and written plans. Since the program code corresponding to each sentence described in the document can be automatically generated, all operations having depended on manpower so far can be automated.

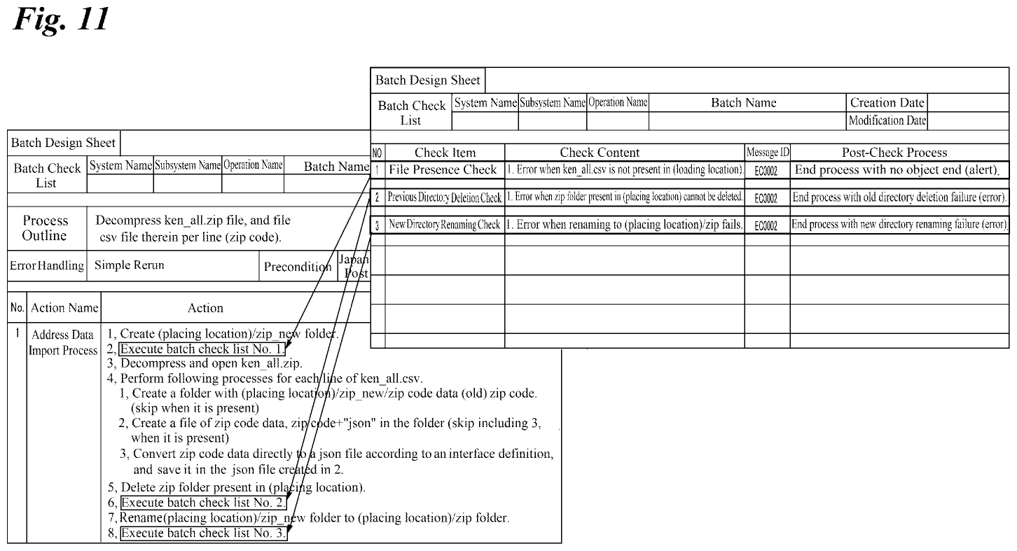

The present invention is not limited to the above-described embodiment. For example, as illustrated in FIG. 11 below, a first association may be applied instead of the first trained model, and a second association may be applied instead of the second trained model.

The first association is configured of a table in which the text data and the semantic content described above are mutually associated so as to correspond one-to-one. The second association is configured of a table in which the semantic content and the program code described above are mutually associated so as to correspond one-to-one.

The first association and the second association as above described are produced in advance. Then, in the actual automatic generation of the program code, first, by referring to the first association, the semantic content associated with text data same as or similar to text data extracted from the document is extracted. Next, by referring to the second association, the program code associated with the extracted semantic content is identified. The procedure of automatically generating the program code after the program code is identified is similar to the above.

Also in the case where the first association is applied instead of the first trained model and the second association is applied instead of the second trained model, similarly, by simply reading thousands of or tens of thousands of sentences included in various kinds of documents, the automatic and accurate program coding is allowed.

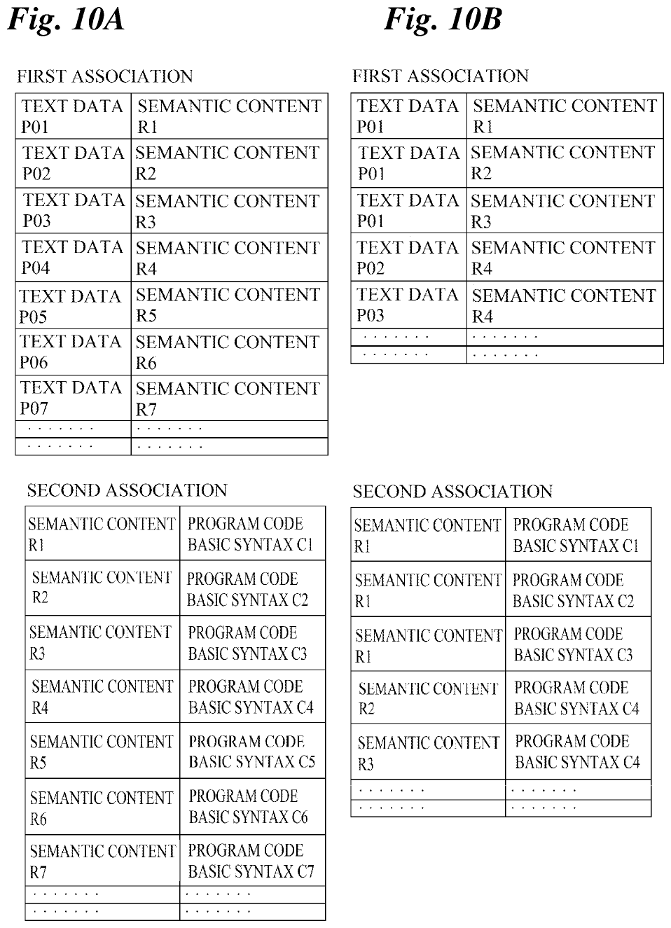

In the first association and the second association, as illustrated in FIG. 10A, the input and the output may be mutually associated in a one-to-one relation, but are not limited thereto. Obviously, as illustrated in FIG. 10B, a plurality of outputs may be associated with one input, or a plurality of inputs may be associated with one output.

### Example 1

FIG. 11 illustrates an example of extracting text data from a document (a design sheet or a document file) in Step S11. As text data described in the document, a character string itself, such as “Create (placing location)/zip_new folder” and “Decompress and open ken_all.zip,” may be extracted. When a description regarding citation, such as “Execute batch check list No. 1” and “Execute batch check list No. 1,” is included, a character string of the citation source is extracted as the text data.

When the process operation of assigning the nouns or the noun phrases specifying the conditions necessary for completing the process operation is performed in Step S14, the folder name “zip_new,” the decompression target “ken_all.zip,” and the like are extracted as the nouns or the noun phrases in the example of FIG. 10. Then, the extracted noun or noun phrase is picked up and assigned to the basic syntax derived in Step S13, thereby allowing completing the program code.

### DESCRIPTION OF REFERENCE SIGNS

1: Automatic program code generation device
2: Terminal
3: Server
4: Communications network
10: Housing
11: Acquisition unit
12: Computation unit
13: Execution unit
14: Storing unit
15: Output unit
16: Intent storage unit
100: Automatic program code generation system
101: CPU
102: ROM
103: RAM
104: Storage unit
105 to 107: I/F
108: Input unit
109: Notification unit
110: Internal bus

1. An automatic program code generation device comprising:
text data extracting means that extracts text data as a text from a document;
semantic content searching means that refers to a first association in which text data from which individual components of a text including a verb, a noun, and a case component are extracted by a morphological analysis is associated with a semantic content, and searches a semantic content highly relevant to the text data extracted by the text data extracting means; and
code extracting means that refers to a second association in which the semantic content is associated with program code basic syntax, and extracts highly relevant program code basic syntax based on the semantic content searched by the semantic content searching means.

2. The automatic program code generation device according to claim 1, wherein:
the semantic content searching means refers to the first association in which the text data is associated with the semantic content with an association degree of three or more levels, and
the code extracting means refers to the second association in which the semantic content is associated with the program code basic syntax with an association degree of three or more levels.

3. The automatic program code generation device according to claim 2, wherein the semantic content searching means and the code extracting means use the association degree corresponding to weighting factors of respective outputs of nodes in a neural network of artificial intelligence.

4. The automatic program code generation device according to claim 1, further comprising:
updating means that updates the first association based on a data set in which semantic contents are preliminarily assigned to respective texts and respective signs included in the text data,
wherein:
the text data extracting means extracts the respective texts and the respective signs included in the text data, and
the semantic content searching means refers to the first association updated by the updating means, and searches semantic contents highly relevant to the respective texts and the respective signs included in the text data extracted by the text data extracting means.

5. The automatic program code generation device according to claim 1, further comprising:
code generating means that generates a program code by assigning a noun or a noun phrase extracted from the text data accepted by the text data extracting means to the program code basic syntax extracted by the code extracting means.

6. A non-transitory computer-readable medium storing an automatic program code generation program that causes a computer to execute operations comprising:
a text data extracting step of extracting text data as a text from a document;
a semantic content searching step of referring to a first association in which text data from which individual components of a text including a verb, a noun, and a case component are extracted by a morphological analysis is associated with a semantic content, and searching a semantic content highly relevant to the text data extracted by the text data extracting step; and
a code extracting step of referring to a second association in which the semantic content is associated with program code basic syntax, and extracting highly relevant program code basic syntax based on the semantic content searched by the semantic content searching step.

7. The non-transitory computer-readable medium according to claim 6, wherein:
the semantic content searching step refers to the first association in which the text data is associated with the semantic content with an association degree of three or more levels, and
the code extracting step refers to the second association in which the semantic content is associated with the program code basic syntax with an association degree of three or more levels.

8. The non-transitory computer-readable medium according to claim 7, wherein the semantic content searching step and the code extracting step use the association degree corresponding to weighting factors of respective outputs of nodes in a neural network of artificial intelligence.

9. The non-transitory computer-readable medium according to claim 6, wherein the operations further comprise:
an updating step of updating the first trained model based on a data set in which semantic contents are preliminarily assigned to respective texts and respective signs included in the text data,
wherein:
the text data extracting step extracts the respective texts and the respective signs included in the text data, and
the semantic content searching step refers to the first trained model updated by the updating step, and searches semantic contents highly relevant to the respective texts and the respective signs included in the text data extracted by the text data extracting step.

10. The non-transitory computer-readable medium according claim 6, wherein the operations further comprise:
a code generating step of generating a program code by assigning a noun or a noun phrase extracted from the text data accepted by the text data extracting step to the program code basic syntax extracted by the code extracting step.
